(19) United States
(12) Patent Application Publication
(10) Pub. No.: US 2023/0384834 A1
(43) Pub. Date: Nov. 30, 2023

(54) COVER WINDOW FOR FLEXIBLE DISPLAY DEVICE AND FLEXIBLE DISPLAY DEVICE

(71) Applicant: LG CHEM, LTD., Seoul (KR)

(72) Inventors: Gieun PARK, Daejeon (KR); Eun Seon LEE, Daejeon (KR); Seung Joon LIM, Daejeon (KR); Yoon Bin LIM, Daejeon (KR); Seungil BAEK, Daejeon (KR); Se Jeong KIM, Daejeon (KR); Myoungseok CHO, Daejeon (KR); Yeongkyu CHOI, Daejeon (KR)

(73) Assignee: LG CHEM, LTD., Seoul (KR)

(21) Appl. No.: 18/249,780

(22) PCT Filed: Aug. 23, 2021
(86) PCT No.: PCT/KR2021/011214

§ 371 Date: Apr. 20, 2023

(30) Foreign Application Priority Data
Nov. 19, 2020 (KR) 10-2020-0155895
Aug. 18, 2021 (KR) 10-2021-0108808

(51) Int. Cl. G06F 1/16; H04M 1/02; G02B 1/14; C09D 183/04; C08J 7/04; C09D 133/10

(52) U.S. Cl. CPC G06F 1/1656; G06F 1/1652; G06F 1/1616; H04M 1/0268; H04M 1/0216; G02B 1/14; C09D 183/04; C08J 7/042; C09D 133/10; C08J 2383/04; C08J 2333/10

(57) ABSTRACT

The present disclosure relates to an optical laminate which hardly has a risk of damaging the film even in repetitive bending or folding operations, and thus can be easily applied to bendable, flexible, rollable or foldable mobile devices, display devices, and the like, to a cover window for flexible display device including the same, and to a flexible display device including the same.

### TECHNICAL FIELD

### Cross-Reference to Related Application(s)

This application claims the benefit of Korean Patent Application No. 10-2020-0155895 filed on Nov. 19, 2020 and Korean Patent Application No. 10-2021-0108808 filed on Aug. 18, 2021 in the Korean Intellectual Property Office, the disclosures of which are incorporated herein by reference in their entirety.

The present disclosure relates to a cover window for flexible display device and a flexible display device.

### BACKGROUND OF THE INVENTION

Recently, with the development of mobile devices such as smartphones and tablet PC, thinning and slimming of substrates for display are required. Glass or tempered glass is commonly used as a material having excellent mechanical properties on windows or front boards for displays of mobile devices. However, the glass causes the weight increase of the mobile devices due to its own weight, and has a problem of breakage due to an external impact.

Thus, studies on plastic resin are actively underway as a material which can replace glass. A plastic resin film is lightweight and less fragile, and thus is suitable for the trend of pursuing lighter mobile devices. In particular, in order to implement a film having high hardness and abrasion resistance properties, films for coating a hard coating layer made of plastic resins onto a support substrate have been proposed.

As a method of increasing the surface hardness of the hard coating layer, a method of increasing the thickness of the hard coating layer may be considered. In order to ensure the surface hardness enough to replace the glass, it is necessary to implement a certain thickness of a hard coating layer. However, as the thickness of the hard coating layer is increased, the surface hardness may be increased but the generaterence of wrinkles and curls are increased due to curing shrinkage of the hard coating layer, and at the same time, cracking and peeling of the coating layer are likely to generate. Therefore, the practical application of this method is not easy.

Meanwhile, a display in which a part of the display device is bent or flexibly warped for aesthetic and functional reasons has recently been attracting attention, and this tendency is noticeable particularly in mobile devices such as smartphones and tablet PCs. However, since glass is not suitable for use as a cover plate for protecting such a flexible display, it needs to be replaced with a plastic resin or the like. However, for that purpose, it is not easy to produce a thin film having sufficient flexibility while exhibiting a glass level of high hardness.

### BRIEF SUMMARY OF THE INVENTION

The present disclosure provides a cover window for flexible display device which hardly has a risk of damaging the film even by repetitive bending or folding operations, and thus, can be easily applied to bendable, flexible, rollable or foldable mobile devices, display devices, and the like.

The present disclosure also provides a flexible display device comprising the above cover window.

According to one aspect of the present disclosure, there is provided a cover window for flexible display device comprising: a light-transmitting substrate; a first coating layer formed on one surface of the light-transmitting substrate and having a thickness of 200 μm or less; and a second coating layer formed on the other surface of the light-transmitting substrate so as to face the first coating layer and including polysiloxane containing two or more repeating units having different structures.

According to another aspect of the present disclosure, there is provided a flexible display device including the above-mentioned cover window for flexible display device.

### DETAILED DESCRIPTION OF THE INVENTION

Hereinafter, a cover window for flexible display device and and a flexible display device according to specific embodiments of the present disclosure will be described in more detail.

In the present disclosure, “flexible” means a state having flexibility to such an extent that cracks of 3 mm or more in length do not generate when wound on a cylindrical mandrel with a diameter of 3 mm. Therefore, the flexible display device of the present disclosure may mean a bendable, flexible, rollable, or foldable display device.

However, these embodiments are given by way of illustration only and the scope of the invention is not limited thereby, and it will be apparent to those skilled in the art that various changes and modifications can be made to the embodiments within the scope and sprit of the present disclosure.

Unless otherwise specified throughout this specification, the technical terms used herein are only for reference to specific embodiments and is not intended to limit the present disclosure.

The singular forms “a”, “an”, and “the” used herein include plural references unless the context clearly dictates otherwise.

The term “including” or “comprising” used herein specifies a specific feature, region, integer, step, action, element and/or component, but does not exclude the presence or addition of a different specific feature, region, integer, step, action, element, component and/or group.

In the present disclosure, the (meth)acrylate means including both methacrylate and acrylate.

As used herein, the weight average molecular weight refers to a weight average molecular weight in terms of polystyrene measured by GPC method. In the process of determining the weight average molecular weight in terms of polystyrene measured by the GPC method, a commonly known analyzing device, a detector such as a refractive index detector, and an analytical column can be used. Commonly applied conditions for temperature, solvent, and flow rate can be used. Specific examples of the measurement condition are as follows: Waters 2695 instrument was used, an evaluation temperature was 40° C., and THF was used for a solvent at a flow rate of 1 mL/min.

According to one embodiment of the present disclosure, there can be provided a cover window for flexible display device comprising: a light-transmitting substrate; a first coating layer formed on one surface of the light-transmitting substrate and having a thickness of 200 μm or less; and a second coating layer formed on the other surface of the light-transmitting substrate so as to face the first coating layer and including polysiloxane containing two or more repeating units having different structures.

The present inventors have conducted research on a cover window applicable to a flexible display device having a thinner thickness, and have found through experiments that the cover window for flexible display device, including a laminated structure which includes a second coating layer including polysiloxane containing two or more repeating units having different structures, on the other surface of the light-transmitting substrate on which the first coating layer having a thickness of 200 μm or less is formed, is implemented so as to simultaneously satisfy the physical property balance between flexibility and high hardness, and also is excellent in impact resistance and pressing-resistance, and thus can secure device stability. The present invention has been completed on the basis of such findings.

More specifically, the cover window for flexible display device does not generate cracks with a length of 3 mm or more when wound on a cylindrical mandrel with a diameter of 3 mm, and thus can not substantially cause damage to a film even by repetitive bending or folding operations. Thereby, the cover window for flexible display device can be easily applied to a bendable, flexible, rollable, or foldable mobile device, a display device, or the like utilizing the same.

Since the cover window for flexible display device can have physical properties that can replace a tempered glass and the like, it can have characteristics to a degree at which it may not be broken by pressure or force applied from the outside and also can be sufficiently warped and folded.

As described above, the physical properties such as bending durability and surface hardness of the cover window for flexible display device may be due to the formation of a first coating layer formed on one surface of the light-transmitting substrate and having a thickness of 200 μm or less; and a second coating layer formed on the other surface of the light-transmitting substrate so as to face the first coating layer and including polysiloxane containing two or more repeating units having different structures.

Specifically, as the cover window for flexible display device according to the one embodiment has a laminated structure that includes: a first coating layer formed on one surface of the light-transmitting substrate and having a thickness of 200 μm or less; and a second coating layer formed on the other surface of the light-transmitting substrate so as to face the first coating layer and including polysiloxane containing two or more repeating units having different structures, it may not include an adhesive layer.

In the case of a conventional cover window for flexible display device, an adhesive layer having a certain thickness was formed, or an adhesive layer such as an adhesive or an adhesive film was formed together with the hard coating layer, in order to secure impact resistance when applied to a display device, or to improve surface hardness or pressing characteristics in a state installed on a display device.

As the cover window for flexible display device according to the embodiment does not include the adhesive layer unlike the conventional cover window for flexible display device, it can implement a flexible display device with a thinner thickness, can realize excellent pressing characteristics even while including the thin first coating layer having a thickness of 200 μm or less, and can minimize damage due to external impact.

Specifically, the cover window for flexible display device according to the embodiment may include a first coating layer having a thickness of 200 μm or less, 10 μm or more and 200 μm or less, 10 μm or more and 100 μm or less, or 10 μm or more and 60 μm or less.

As described above, the cover window for flexible display device according to the embodiment has a laminated structure that includes: a first coating layer formed on one surface of the light-transmitting substrate and having a thickness of 200 μm or less; and a second coating layer formed on the other surface of the light-transmitting substrate so as to face the first coating layer and including polysiloxane containing two or more repeating units having different structures, and thereby, can realize excellent pressing characteristics even while including a thin first coating layer with a thickness of 200 μm or less, and can minimize damage due to external impact.

Meanwhile, the cover window for flexible display device according to the embodiment does not generate cracks of 1 mm or more when it is placed at an interval of 8 mm in the middle of the first coating layer, and operations of folding and unfolding toward the inside of the first coating layer at an angle of 90 degrees so that the first coating layer faces are repeated 200,000 times at a speed of 1 time/second at room temperature, it hardly has a risk of damaging the film even by repetitive bending or folding operations, and thus, can be easily applied to bendable, flexible, rollable or foldable mobile devices, display devices, and the like.

FIG. 1 schematically shows a method for measuring dynamic bending characteristics.

Referring to FIG. 1, the cover window for flexible display device is placed so as to be horizontal with the bottom, and the interval between the portions folded at a middle portion of the first coating layer is set to n mm. Then, operations of folding and unfoling both sides of the first coating layer at 90 degrees toward the bottom surface are repeated 200,000 times at 25° C. at a speed of 1 time/second, thereby measuring the durability against bending. At this time, in order to maintain the constant interval between the folded portions, for example, the first coating layer is placed so as to be in contact with a rod having a diameter (R) of n mm, the remaining portion of the first coating layer is fixed, and the operations of folding and unfolding both sides of the first coating layer around the rod can be performed. Further, the folded portion is not particularly limited as long as it is the inside of the first coating layer, and for convenience of measurement, the central portion of the first coating layer can be folded so that the remaining both sides of the first coating layer excluding the folded portion are symmetrical.

In evaluating such dynamic bending characteristics, the cover window for flexible display device does not generate cracks of 1 cm or more, or 1 mm or more even after bending 200,000 times, and does not substantially generate cracks. Therefore, the possibility of occurrence of cracks is extremely low even in actual application conditions such as repeatedly folding, rolling or warping, and thereby, it can be suitably applied for the cover window for flexible display device.

Meanwhile, the cover window for flexible display device according to the one embodiment may include a functional layer of 10 μm to 300 μm formed on one surface of the second coating layer formed on the other surface of the light-transmitting substrate so as to face the first coating layer.

In the cover window for flexible display device according to the one embodiment, the type of the functional layer is not particularly limited, and various functional layers applicable to the flexible display device can be applied. Specifically, the functional layer may be any one of a black matrix film, a polarizing film, an ultraviolet blocking film, a release film, and a conductive film.

In the cover window for flexible display device according to the one embodiment, the functional layer may have a thickness of 10 μm to 300 μm, 10 μm to 100 μm, or 3 μm to 30 μm.

When the thickness of the functional layer exceeds 300 μm, the flexibility may decrease, making it difficult to form a flexible film.

For the cover window for flexible display device according to the one embodiment, immediately after a functional layer of 10 μm to 300 μm is formed on one surface of the second coating layer formed on the other surface of the light-transmitting substrate so as to face the first coating layer, the maximum hardness that pressing does not generate in a path through which a pencil passes on the surface of the first coating layer may be 2B or more, 2B or more and 5H or less, B or more and 5H or less, or B or more and HB or less, as measured according to JIS K5400 standard method using a pencil hardness tester.

For the cover window for flexible display device according to the one embodiment, immediately after a functional layer of 10 μm to 300 μm is formed on one surface of the second coating layer formed on the other surface of the light-transmitting substrate so as to face the first coating layer, the maximum hardness that pressing does not generate in a path through which a pencil passes on the surface of the first coating layer is 2B or more, as measured according to JIS K5400 standard method using a pencil hardness tester, whereby it can realize excellent pressing-resistance and thus hardly has a risk of damaging the film even by repetitive bending or folding operations, realizes device stability and thus, can be applied to a cover window for flexible display device, and bendable, flexible, rollable or foldable mobile devices, display devices, and the like, using the same.

Specifically, in the cover window for flexible display device, the second coating layer may include polysiloxane containing two or more repeating units having different structures. More specifically, the second coating layer may include polysiloxane containing two or more repeating units in which a crosslinkable functional group is substituted.

As the second coating layer includes polysiloxane containing two or more repeating units in which a crosslinkable functional group is substituted, the cage-type polysiloxane repeating unit can increase the curing density, making it possible to realize high hardness, and the ladder-type polysiloxane repeating unit can improve the flexibility of the cured film through a flexible molecular structure. For this reason, the cover window for flexible display device according to the embodiment may exhibit a physical property balance between a high flexibility and a high hardness.

Polysiloxane may have a variety of structures. For example, it may have a structure of a cage-type polysiloxane repeating unit, a ladder-type polysiloxane repeating unit, and an arbitrary-type polysiloxane repeating unit.

As the cover window for flexible display device according to the embodiment includes polysiloxane containing two or more repeating units having different structures, it may include a cage-type polysiloxane repeating unit and a ladder-type polysiloxane repeating unit, or include a cage-type polysiloxane repeating unit and an arbitrary-type polysiloxane repeating unit, or include a ladder-type polysiloxane repeating unit and an arbitrary-type polysiloxane repeating unit, or all of a cage-type polysiloxane repeating unit, a ladder-type polysiloxane repeating unit and an arbitrary-type polysiloxane repeating unit.

More specifically, polysiloxane containing two or more repeating units having different structures may include a cage-type polysiloxane repeating unit in which a cross-linkable functional group is substituted, and a ladder-type polysiloxane repeating unit in which a cross-linkable functional group is substituted.

In the cover window for flexible display device according to the one embodiment, as the second coating layer includes both a cage-type polysiloxane repeating unit and a ladder-type polysiloxane repeating unit, it has the effect that the cage type having a relatively small molecular weight increases the curing density and increases the hardness, and the linear ladder type polysiloxane is widely distributed during the formation of a cured network to increase flexibility and toughness, as compared with the case where only one type of polysiloxane repeating unit of a cage-type polysiloxane repeating unit or a ladder-type polysiloxane repeating unit is included. Thereby, the cover window for flexible display device according to the embodiment can exhibit a physical property balance between high flexibility and high hardness.

Further, as the molar ratio of the cage-type polysilsesquioxane repeating unit to the ladder-type polysilsesquioxane repeating unit may be 1.2 or more and 2.5 or less, 1.2 or more and 2.0 or less, 1.2 or more and 1.8 or less, or 1.4 or more and 1.8 or less. As the molar ratio is 1.2 to 2.5, the cage and the ladder shape can be harmonized to form a composition, the cover window can exhibit a physical property balance between a high flexibility and a high hardness. Specifically, the cage-type polysilsesquioxane structure can increase the curing density, making it possible to realize a high hardness, and the ladder-type polysilsesquioxane structure improves the flexibility of the cured film through a flexible molecular structure. Therefore, as the cage-type polysilsesquioxane repeating unit and the ladder-type polysilsesquioxane repeating unit are included in a specific ratio, it can simultaneously realize high flexibility and high hardness properties.

In a FT-IR (Fourier Transform-Infra Red) spectrum measured by an attenuated total reflection (ATR) method using polysiloxane containing two or more repeating units having different structures, it may have at least one peak in the region of 1010 cm⁻¹ to 1070 cm⁻¹, and have at least one peak in the region of 1075 cm⁻¹ to 1130 cm⁻¹.

For example, in the FT-IR spectrum, at least one peak can appear in the region of 1010 cm⁻¹ to 1070 cm⁻¹, 1030 cm⁻¹ to 1065 cm⁻¹, or 1040 cm⁻¹ to 1060 cm⁻¹, and at least one peak can appear in the region of 1075 cm⁻¹ to 1130 cm⁻¹, 1080 cm⁻¹ to 1110 cm⁻¹, or 1090 cm⁻¹ to 1100 cm⁻¹.

As peaks are respectively shown in two or more different regions in the FT-IR spectrum by the ATR method, polysiloxane included in the second coating layer of the cover window for flexible display device may include two or more repeating units having different structures.

Specifically, in the region of 1010 cm⁻¹ to 1070 cm⁻¹, two or more peaks can appear or only one peak can appear. The peak appearing in the region of 1010 cm⁻¹ to 1070 cm⁻¹ may be a peak related to the ladder-type polysiloxane. In addition, in the region of 1075 cm⁻¹ to 1130 cm⁻¹, two or more peaks can appear or only one peak can appear, and the peak appearing in the region of 1075 cm⁻¹ to 1130 cm⁻¹ may be a peak related to the cage-type polysiloxane.

Further, a peak intensity ratio (I₂/I₁) of intensity (I₂) of the peak with the highest intensity among at least one peak appearing in the region of 1075 cm⁻¹ to 1130 cm⁻¹ to intensity (I₁) of the peak with the highest intensity among at least one peak appearing in the region of 1010 cm⁻¹ to 1070 cm⁻¹ is 1.2 or more and 2.5 or less, 1.2 or more and 2.0 or less, 1.2 or more and 1.8 or less, or 1.4 or more and 1.8 or less.

The intensity (I₁) of the peak means the intensity of the peak with the highest intensity when two or more peaks appear in the region of 1010 cm⁻¹ to 1070 cm⁻¹, and it means the intensity of the corresponding peak when one peak appears. In addition, the intensity (I₂) of the peak means the intensity of the peak with the highest intensity when two or more peaks appear in the region of 1075 cm⁻¹ to 1130 cm⁻¹, and it means the intensity of the corresponding peak when one peak appears.

The peak intensity ratio (I₂/I₁) can be measured in an FT-IR spectrum by an ATR method using polysiloxane in an uncured state before curing process or in a solid state after curing as a sample.

As the peak intensity ratio (I₂/I₁) is 1.2 to 2.5, the cage type and the ladder type can be harmonized to form the composition, so that the cover window can exhibit a physical property balance between a high flexibility and a high hardness. When the peak intensity ratio (I₂/I₁) is less than 1.2 or more than 2.5, flexibility is deteriorated and hardness is also lowered, so that sufficient physical properties for use in a cover window for flexible display device can not be realized.

Meanwhile, the crosslinkable functional group may include any one selected from the group consisting of an alicyclic epoxy group and a functional group represented by the following Chemical Formula 1.

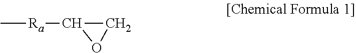

wherein, in Chemical Formula 1, R a is a substituted or unsubstituted alkylene group having 1 to 6 carbon atoms, a substituted or unsubstituted alkenylene group having 2 to 20 carbon atoms, a substituted or unsubstituted alkynylene group having 2 to 20 carbon atoms, —R_{b}—CH═CH—COO—R_{c}—, —R_{d}—OCO—CH═CH—Rₑ—, —R_{f}OR_{g}—, —RₕCOORᵢ—, or —RⱼCORₖ—, and R_{b} to Rₖ are each independently a single bond, or a substituted or unsubstituted alkylene group having 1 to 6 carbon atoms.

As the functional group represented by Chemical Formula 1 includes an epoxy group, it not only improves the physical properties of high hardness and scratch resistance of the cover window for flexible display device, but also causes almost no damage to a film even by repetitive bending or folding operations, and thus can be easily applied to bendable, flexible, rollable, or foldable mobile devices, display devices, and the like.

For example, the functional group Ra represented by Chemical Formula 1 may be methylene, ethylene, propylene, allylene, —R_{b}—CH═CH—COO—R_{c}—, —R_{d}—OCO—CH═CH—Rₑ—, —R_{f}OR_{g}—, —RₕCOORᵢ—, or —RⱼOCORₖ—. For example, in Chemical Formula 1, R_{b} to Rₖ may be a single bond, methylene, ethylene, propylene, or butylene. For example, R a may be methylene, ethylene, or —R_{f}OR_{g}—, where R_{f} and R_{g} may be a direct bond, methylene or propylene. For example, the functional group represented by Chemical Formula 1 may include, but not limited thereto, a glycidoxy group, a glycidoxyethyl group, a glycidoxypropyl group, or a glycidoxy butyl group.

Further, the alicyclic epoxy group is not limited thereto, but may be, for example, an epoxycyclohexyl group, an epoxycyclopentyl group, or the like.

In other words, the polysiloxane repeating unit in which the crosslinkable functional group is substituted may include a (R¹SiO_{3/2}) silsesquioxane unit as a T3 unit.

In the silsesquioxane structural unit of (R¹SiO_{3/2}), R¹ may be a crosslinkable functional group. Specifically, the R¹ may be any one selected from the group consisting of an alicyclic epoxy group and a functional group represented by the Chemical Formula 1.

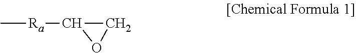

wherein, in Chemical Formula 1, R a may be a substituted or unsubstituted alkylene group having 1 to 6 carbon atoms, a substituted or unsubstituted alkenylene group having 2 to 20 carbon atoms, a substituted or unsubstituted alkynylene group having 2 to 20 carbon atoms, —R_{b}—CH═CH—COO—R_{c}—, —R_{d}—OCO—CH═CH—Rₑ—, —R_{f}OR_{g}—, —RₕCOORᵢ—, or —RⱼCORₖ—, and R_{b} to Rₖ may be each independently a single bond, or a substituted or unsubstituted alkylene group having 1 to 6 carbon atoms.

More specifically, in Chemical Formula 1, Ra is methylene, ethylene, propylene, allylene, —R_{b}—CH═CH—COO—R_{c}—, —R_{d}—OCO—CH═CH—Rₑ—, —R_{f}OR_{g}—, —RₕCOORᵢ—, or —RⱼOCORₖ—. At this time, R_{b} to Rk may be each independently a single bond, or a substituted or unsubstituted alkylene group having 1 to 6 carbon atoms, and more specifically, it may be a single bond or a linear alkylene group having 1 to 6 carbon atoms such as methylene, ethylene, propylene, butylene, and the like. More specifically, R a may be methylene, ethylene, or —R_{f}OR_{g}—, where R_{f} and R_{g} may be a direct bond or a linear alkylene group having 1 to 6 carbon atoms such as methylene or propylene.

Considering the effect of improving the surface hardness and curability of the cured product, R¹ may be a glycidyl group or a glycidoxypropyl group.

Further, when R a is substituted, specifically, it may be substituted with one or more substituents selected from the group consisting of an alkyl group having 1 to 12 carbon atoms, a cycloalkyl group having 3 to 12 carbon atoms, an alkenyl group having 2 to 12 carbon atoms, a hydroxy group, an alkoxy group having 1 to 12 carbon atoms, an amino group, an acryl group (or an acryloyl group); a methacryl group (or methacryloyl group), an acrylate group (or an acryloyloxy group); a methacrylate group (or methacryloyloxy group), a halogen group, a mercapto group, an ether group, an ester group, an acetyl group, a formyl group, a carboxyl group, a nitro group, a sulfonyl group, an urethane group, an epoxy group, an oxetanyl group and a phenyl group. More specifically, it may be substituted with one or more substituents selected from the group consisting of an alkyl group having 1 to 6 carbon atoms such as methyl and ethyl; an acryl group; a methacryl group; an acrylate group; a methacrylate group; a vinyl group; an allyl group; an epoxy group; and an oxetanyl group.

Further, the polysiloxane is a T3 unit together with the silsesquioxane unit of the above-mentioned (R¹SiO_{3/2}), and may further include a silsesquioxane unit of (R²SiO_{3/2}). The silsesquioxane unit of (R²SiO_{3/2}) can increase the curing density of the polysiloxane and improve the surface hardness characteristics of the coating layer.

In the silsesquioxane structural unit of (R²SiO_{3/2}), R₂ is specifically a substituted or unsubstituted alkyl group having 1 to 12 carbon atoms, a substituted or unsubstituted cycloalkyl group having 3 to 12 carbon atoms, a substituted or unsubstituted aryl group having 6 to 12 carbon atoms, a substituted or unsubstituted arylalkyl group having 7 to 12 carbon atoms, aA substituted or unsubstituted alkylaryl group; Epoxy group having 7 to 12 carbon atoms, an epoxy group, an oxetanyl group, an acrylate group, a methacrylate group and a hydrogen atom.

Further, the R² may be substituted with with one or more substituents selected from the group consisting of an alkyl group having 1 to 12 carbon atoms, a cycloalkyl group having 3 to 12 carbon atoms, an alkenyl group having 2 to 12 carbon atoms, a hydroxy group, an alkoxy group having 1 to 12 carbon atoms, an amino group, an acryl group, a methacryl group, a acrylate group, a methacrylate group, a halogen group, a mercapto group, an ether group, an ester group, an acetyl group, a formyl group, a carboxyl group, a nitro group, a sulfonyl group, an urethane group, an epoxy group, an oxetanyl group and phenyl group. More specifically, it may be substituted with with one or more substituents selected from the group consisting of an acryl group, a methacryl group, an acrylate group, a methacrylate group, a vinyl group, an allyl group, an epoxy group and an oxetanyl group.

Among them, in terms of the effects of further increasing the curing density of polysiloxane and thus further improving the surface hardness property of the coating layer, more specifically, the R² may be an alkyl group having 1 to 6 carbon atoms or a phenyl group having 1 to 6 carbon atoms, which is unsubstituted or substituted with one or more substituents selected from the group consisting of an acryl group, a methacryl group, an acrylate group, a methacrylate group, a vinyl group, an allyl group, an epoxy group and an oxetanyl group; or an epoxy group; or an oxetanyl group. More specifically, the R₂ may be an unsubstituted phenyl group or an epoxy group.

Meanwhile, as used herein, the ‘epoxy group’ is a functional group containing an oxirane ring, and may include, unless otherwise stated, an unsubstituted epoxy group containing only the oxirane ring, an alicyclic epoxy group having 6 to 20 carbon atoms or 6 to 12 carbon atoms (e.g., epoxycyclohexyl, epoxycyclopentyl, etc.); and an aliphatic epoxy group having 3 to 20 carbon atoms or 3 to 12 carbon atoms (e.g., a glycidyl group, etc.).

Further, as used herein, the ‘oxetanyl group’ is a functional group containing an oxetane ring, and may include, unless otherwise stated, an unsubstituted oxetanyl group containing only the oxetane ring, an alicyclic oxetanyl group having 6 to 20 carbon atoms or 6 to 12 carbon atoms, and an aliphatic oxetanyl group having 3 to 20 carbon atoms or 3 to 12 carbon atoms.

Further, the polysiloxane may include a structural unit of (OR). The polysiloxane can improve flexibility while maintaining excellent hardness property by including the structural unit. The R may be specifically a hydrogen atom or an alkyl group having 1 to 12 carbon atoms, and more specifically a hydrogen atom or a linear or branched alkyl group having 1 to 4 carbon atoms such as a methyl group, an ethyl group, a propyl group, an isopropyl group, a butyl group, an isobutyl group, etc.

The polysiloxane including the structural units may be prepared by hydrolysis and condensation reaction of the siloxane monomers of the respective structural units, specifically, the alkoxysilane having an epoxyalkyl group alone or between the alkoxysilane having an epoxyalkyl group and heterogeneous alkoxysilane. In this regard, a molar ratio of the respective structural units may be controlled by controlling a content ratio of the alkoxysilane.

Meanwhile, in the cover window for flexible display device according to the embodiment, the second coating layer may include an elastomeric polymer.

The elastomeric polymer is included in the second coating layer, and thereby, stress resistance properties are given through high toughness to the second coating layer and shrinkage during curing can be minimized. As a result, the curl properties can be improved and at the same time, flexibility such as bending property can be improved.

The elastomeric polymer may include alkanediol having 1 to 20 carbon atoms, polyolefin polyol, polyester polyol, polycaprolactone polyol, polyether polyol or polycarbonate polyol, and the like, and any one thereof or a mixture of two or more thereof may be used. These elastomeric polymers can be crosslinked and polymerized by ultraviolet irradiation as compared to conventional elastomeric polymers such as rubber, and high hardness and flexibility can be achieved without deterioration of the other physical properties. Among these, the elastomeric polymer may be a polycaprolactone diol, and particularly, in the polycaprolactone diol, an ester group and an ether group are contained and repeated in the repeating unit at the same time, and thereby, it can exhibit a more excellent effect in terms of flexibility, hardness and impact resistance when used in combination with two or more epoxy polysiloxanes in which the crosslinked functional group is substituted.

Further, the elastomeric polymer may have a number average molecular weight (Mn) of 500 to 10,000 Da, more specifically 1,000 to 5,000 Da. When the above number average molecular weight condition is satisfied, the compatibility with other components may be increased, and the surface hardness of the cured product may be improved, thereby further improving heat resistance and abrasion resistance of the cured product.

In the cover window for flexible display device according to the embodiment, the second coating layer may contain the elastomeric polymer in an amount of 10 parts by weight or more and parts by weight or less, 10 parts by weight or more and 75 parts by weight or less, 10 parts by weight or more and 50 parts by weight or less, or 15 parts by weight or more and 50 parts by weight or less with respect to 100 parts by weight of polysiloxane containing two or more repeating units having the different structures.

As the second coating layer contains the elastomeric polymer in an amount of 10 parts by weight or more and 80 parts by weight or less with respect to 100 parts by weight of polysiloxane containing two or more repeating units having different structures, the cover window for flexible display device of the embodiment may have excellent optical properties and may realize a physical property balance between flexibility and high hardness.

When the elastomeric polymer is contained in an amount of less than 10 parts by weight with respect to 100 parts by weight of polysiloxane containing two or more repeating units having different structures, technical problems may arise in which a strong cured film cannot be formed and durability against repeated bending or folding operations cannot be sufficiently implemented.

When the elastomeric polymer is contained in an amount of more than 80 parts by weight with respect to 100 parts by weight of polysiloxane containing two or more repeating units having different structures, flexibility at the time of curing is reduced and the partially uncured portion occurs, which may cause a problem in that hardness is lowered.

Meanwhile, the first coating layer may include a (meth)acrylate resin or an epoxy resin.

Specifically, the epoxy resin may include polysiloxane containing two or more repeating units in which a crosslinkable functional group is substituted. The content concerning the polysiloxane containing two or more repeating units in which the crosslinkable functional group is substituted includes all the above-mentioned contents.

Meanwhile, since the hard coating layer contains an epoxy resin, a strong cured film can be formed to secure durability against repeated bending or folind operations. When the hard coating layer does not include an epoxy resin, a technical problem may occur in which durability against repeated bending or folding operations is deteriorated.

The type of the epoxy resin is not particularly limited, but may include a bisphenol-based epoxy resin.

For example, the epoxy resin may include one or more selected from the group consisting of bisphenol A-type epoxy resin, bisphenol F-type epoxy resin, bisphenol S-type epoxy resin, bisphenol A-type novolac epoxy resin, and hydrogenated bisphenol A-type epoxy resin.

As the epoxy resin contains a bisphenol-based epoxy resin, it is relatively straight and rigid compared to the silsesquioxane molecular structure, and thus the molecular chain of the cured film also has excellent rigidity and exhibits high Tg and low CTE values, and can realize excellent durability against repeated bending or folding operations at high and low temperatures, as compared to the case where a linear epoxy resin such as a polyethylene glycol-based epoxy resin is contained.

More specifically, the epoxy resin may have an epoxy equivalent weight of 120 g/eq or more and 600 g/eq or less, 120 g/eq or more and 550 g/eq or less, 150 g/eq or more and 550 g/eq or less, 155 g/eq or more and 500 g/eq or less.

When the epoxy equivalent weight of the epoxy resin is less than 120 g/eq, a curable epoxy reaction group exists in an excess amount, it is partially uncured during the curing reaction, or the cured film may become brittle, and thus, the durability against repeated bending or folding operations at low temperatures may be inferior. When the epoxy equivalent weight exceeds 600 g/eq, a technical problem may occur in which the optical properties of the hard coating layer are deteriorated.

The equivalent weight of these functional groups is a value obtained by dividing the molecular weight of the epoxy resin by the number of epoxy functional groups, and can be analyzed by H-NMR or chemical titration.

In addition, the (meth)acrylate resin may include a (co)polymer of at least one compound selected from the group consisting of a monofunctional or polyfunctional acrylate monomer and a polyfunctional urethane acrylate oligomer.

The monofunctional or polyfunctional acrylate monomer may include 2-ethylhexyl acrylate, octadecyl acrylate, isodecyl acrylate, 2-phenoxyethyl acrylate, lauryl acrylate, stearyl acrylate, behenyl acrylate, tridecyl methacrylate, nonylphenol ethoxylate monoacrylate, β-carboxyethyl acrylate, isobornyl acrylate, tetrahydrofurfuryl acrylate, tetrahydrofurfuryl methacrylate, 4-butylcyclohexyl acrylate, dicyclopentenyl acrylate, dicyclopentenyl oxyethyl acrylate, ethoxyethoxyethyl acrylate, ethoxylated monoacrylate, 1,6-hexanediol diacrylate, triphenylglycol diacrylate, butanediol diacrylate, 1,3-butylene glycol dimethacrylate, 1,6-hexanediol dimethacrylate, neopentyl glycol diacrylate, ethylene glycol dimethacrylate, diethylene glycol diacrylate, diethylene glycol dimethacrylate, tetraethylene glycol diacrylate, tetraethylene glycol dimethacrylate, triethylene glycol diacrylate, triethylene glycol dimethacrylate, polyethylene glycol diacrylate, polyethylene glycol dimethacrylate, dipropylene glycol diacrylate, ethoxylated neopentyl glycol diacrylate, trimethylolpropane triacrylate, trimethylolpropane trimethacrylate, pentaerythritol triacrylate, pentaerythritol trimethacrylate, pentaerythritol tetramethacrylate, pentaerythritol tetraacrylate, ethoxylated triacrylate, tris(2-hydroxyethyl)isocyanurate triacrylate, dipentaerythritol pentaacrylate, ditrimethylolpropane tetraacrylate, alkoxylated tetraacrylate, and the like, and preferably, may include acrylate monomers such as pentaerythritol triacrylate, pentaerythritol trimethacrylate, pentaerythritol tetramethacrylate, or pentaerythritol tetraacrylate, and any one thereof or a mixture of two or more thereof may be used.

In addition, when the polyfunctional urethane acrylate oligomer is used in combination with the above-mentioned polysiloxane, the effect of improving surface hardness can be remarkable.

The urethane acrylate oligomer may have 6 to 9 functional groups. When the number of functional groups is less than 6, the effect of improving hardness may be insignificant, and when the number of functional groups is more than 9, the hardness is excellent, but the viscosity can be increased. Moreover, the polyfunctional urethane acrylate oligomer can be used without limitation, as long as it is those used in the art. Preferably, those prepared by reacting a compound having at least one isocyanate group in the molecule with a (meth)acrylate compound having at least one hydroxyl group in the molecule can be used.

Additionally, in the cover window for flexible display device according to one embodiment of the present disclosure, the first coating layer may also include an elastomeric polymer. When an elastomeric polymer is further included in the first coating layer in this way, the shrinkage can be minimized during curing of the first coating layer, thus further improving the bending characteristics and flexibility.

Further, when the first coating layer further includes an elastomeric polymer, the content of the elastomeric polymer included in the first coating layer and the second coating layer may be the same or different. Considering the surface hardness properties, curl properties and bending line improvement effects due to the minimization of shrinkage in the lower coating layer in contact with the light-transmitting substrate, the cover window for flexible display device according to one embodiment of the present disclosure may contain an elastomeric polymer in a higher content in the second coating layer than in the first coating layer.

Meanwhile, the cover window for flexible display device includes, preferably, a light-transmitting substrate that not only has excellent optical properties and simultaneously satisfies a physical property balance between flexibility and high hardness in order to realize the above-mentioned properties, but also can prevent damage to the internal structure even by repeated bending or folding operations.

The type of the light-transmitting substrate is not particularly limited as long as it satisfies the above-mentioned properties, but for example, it may use a glass substrate, or may include one or more resins selected from the group consisting of a polyester-based resin, a cellulose-based resin, a polycarbonate-based resin, an acryl-based resin, a styrene-based resin, a polyolefin-based resin, a polyimide-based resin, a polyamide imide-based resin, a polyethersulfone-based resin and a sulfone-based resin.

The light-transmitting substrate may have an elastic modulus of about 4 GPa or more, or about 5 GPa or more, or about 5.5 GPa or more, or about 6 GPa or more, or an elastic modulus of 4 GPa to 9 GPa.

When the elastic modulus of the light-transmitting substrate is less than 4 GPa, the cover window for flexible display device may not achieve sufficient hardness. Further, when the elastic modulus of the light-transmitting substrate exceeds 9 GPa, the flexibility and elasticity of the cover window for flexible display device may not be sufficient.

As described above, a film or an optical laminate having a thin thickness can generally secure flexibility but it is not easy to secure durability against repeated bending or folding operations while ensuring high surface strength.

In contrast, the cover window for flexible display device of the embodiment has a first coating layer and a second coating layer that can secure durability against repeated bending or folding operations while having high hardness together with the light-transmitting substrate of the above-described properties, and may have the same characteristics as described above.

On the other hand, the cover window for flexible display device satisfies a physical property balance between flexibility and high hardness at the same time even in a thin thickness range compared to the other cover windows for flexible display devices previously known, and can prevent damage to the internal structure even by repeated bending or folding operations, and can have optical properties such as high transparency along with high mechanical properties and heat resistance.

More specifically, the light-transmitting substrate may have a thickness of 5 μm to 100 μm, or a thickness of 10 μm to 80 μm, or a thickness of 20 μm to 60 μm. When the thickness of the substrate is less than 5 μm, there is a risk of breakage or curling during the coating layer forming process, and it may be difficult to achieve high hardness. On the other hand, when the thickness exceeds 100 μm, the flexibility may be reduced, and it may be difficult to form a flexible film.

The first coating layer may have a thickness of 200 μm or less, 10 μm or more and 200 μm or less, 10 μm or more and 100 μm or less, or 10 μm or more and 60 μm or less. When the thickness of the first coating layer is excessively increased, the flexibility of the cover window for flexible display device or durability against repeated bending or folding operations may be deteriorated.

The second coating layer may have a thickness of 5 μm to 200 μm, or 5 μm to 100 μm, or 10 μm to 80 μm, or 20 μm to 80 μm. When the thickness of the second coating layer is less than 5 μm, there is a risk of breakage or curling during the coating layer forming process, and it may be difficult to achieve high hardness. On the other hand, when the thickness exceeds 100 μm, the flexibility may be reduced, and it may be difficult to form a flexible film.

Further, the cover window for flexible display device of the embodiment may have a thickness of 80 μm to 350 μm, 80 μm to 300 μm, 80 μm to 250 μm, or 80 μm to 210 μm. That is, the thickness of the laminate including the second coating layer, the light-transmitting substrate, and the first coating layer may be 80 μm to 350 μm, 80 μm to 300 μm, 80 μm to 250 μm or 80 μm to 210 μm. When the thickness of the cover window for flexible display device is less than 80 μm, there is a risk of breakage or curling during the coating layer forming process, and may be difficult to achieve high hardness. On the other hand, when the thickness exceeds 350 μm, the flexibility may be reduced and it may be difficult to form a flexible film.

Further, in the cover window for flexible display device, a ratio of a thickness of the first coating layer to a thickness of the light-transmitting substrate may be 0.1 to 2.0.

Specifically, in the cover window for flexible display device, the ratio of the thickness of the first coating layer to the thickness of the light-transmitting substrate may be 0.1 or more and or more, may be 2.0 or less, 1.5 or less, 1.0 or less, or 0.5 or less, and may be 0.1 to 2.0, 0.1 to 1.5, 0.1 to 1.0, or 0.2 to 1.0, or 0.2 to 0.5. As the cover window for flexible display device satisfies the feature that the ratio of the thickness of the first coating layer to the thickness of the light-transmitting substrate is 0.1 to 2.0, it is possible to suppress the occurrence of breakage or curl during the coating layer forming process and achieve high hardness, and at the same time, realize sufficient flexibility to achieve a physical property balance between flexibility and high hardness.

Further, in the cover window for flexible display device, the ratio of the thickness of the second coating layer to the thickness of the first coating layer may be 1.0 to 10.0.

Specifically, in the cover window for flexible display device, the ratio of the thickness of the second coating layer to the thickness of the first coating layer may be 1.0 or more, 2.0 or more, 4.0 or more, may be 10.0 or less, 8.0 or less, or 6.0 or less, and may be 2.0 to 10.0, 2.0 to 8.0, 4.0 to 8.0, or 4.0 to 6.0.

As the cover window for flexible display device satisfies the feature that the ratio of the thickness of the second coating layer to the thickness of the first coating layer is 1.0 to 10.0, it is possible to suppress the occurrence of breakage or curl during the coating layer forming process and achieve high hardness, and at the same time, realize sufficient flexibility to achieve a physical property balance between flexibility and high hardness.

Meanwhile, the cover window for flexible display device can be provided by coating the coating composition for forming the first coating layer onto one surface of the light-transmitting substrate and photocuring it, and then coating the coating composition for forming the second coating layer onto the other surface of the light-transmitting substrate and photocuring it.

The method of coating the coating composition is not particularly limited as long as it can be used in the technical field to which the present technology belongs, and for example, a bar coating method, a knife coating method, a roll coating method, a blade coating method, a die coating method, a micro gravure coating method, a comma coating method, a slot die coating method, a lip coating method, a solution casting method, or the like can be used.

It may further include at least one selected from a layer, a membrane, a film or the like such as a plastic resin film, a release film, a conductive film, a electric conductive layer, a liquid crystal layer, a coating layer, a cured resin layer, a non-conductive film, a metal mesh layer or a patterned metal layer on the top surface of the first coating layer or between the photo-transmitting substrate film or the polymer substrate and the first coating layer.

For example, an antistatic layer having conductivity is first formed on a substrate, and then a coating layer is formed thereon to provide an anti-static function, or a low refractive index layer is introduced on the coating layer to implement a low reflection function.

Further, the layer, membrane, film or the like may be in any form of a single layer, a double layer, or a laminate type. The layer, membrane, film or the like may be formed by laminating a freestanding film with an adhesive, a cohesive film, or the like, or may be laminated on the coating layer by a method such as coating, vapor deposition, sputtering, or the like, but the present invention is not limited thereto.

Meanwhile, the first coating layer and the second coating layer may further include components commonly used in the art, such as a photoinitiator, an organic solvent, a surfactant, a UV absorber, a UV stabilizer, an anti-yellowing agent, a leveling agent, an antifouling agent, a dye for improving the color value, etc., in addition to the above-mentioned binder resin, inorganic fine particles and the like. Further, since the content thereof can be variously adjusted within the range that does not deteriorate the physical properties of the coating layer, it is not particularly limited. However, for example, they may be contained in an amount of about 0.01 to about 30 parts by weight based on about 100 parts by weight of the coating layer.

The surfactant may be a mono- or bi-functional fluorine-based acrylate, a fluorine-based surfactant, or a silicon-based surfactant. In this case, the surfactant may be included in a form of being dispersed or crosslinked in the crosslinked copolymer.

Further, the additive may include a UV absorber, or a UV stabilizer, and the UV absorber may include a benzophenone-based compound, a benzotriazole-based compound, a triazine-based compound or the like. The UV stabilizer may include tetramethyl piperidine or the like.

The photoinitiator may include 1-hydroxy-cyclohexyl-phenyl ketone, 2-hydroxy-2-methyl-1-phenyl-propanone, 2-hydroxy-1-[4-(2-hydroxyethoxy)phenyl]-2-methyl-1-propanone, methylbenzoylformate, α,α-dimethoxy-α-phenyl acetophenone, 2-benzoyl-2-(dimethylamino)-1-[4-(4-morpholinyl)phenyl]-1-butanone, 2-methyl-1-[4-(methylthio)phenyl]-2-(4-morpholinyl)-1-propanone diphenyl(2,4,6-trimethylbenzoyl)-phosphine oxide, or bis(2,4,6-trimethylbenzoyl)-phenylphosphine oxide, and the like, but are not limited thereto. In addition, commercially available products include Irgacure 184, Irgacure 500, Irgacure 651, Irgacure 369, Irgacure 907, Darocur 1173, Darocur MBF, Irgacure 819, Darocur TPO, Irgacure 907, Esacure KIP 100F, and the like. These photoinitiators can be used alone or in combination of two or more.

The organic solvent may include alcohol based solvents such as methanol, ethanol, isopropyl alcohol and butanol; alkoxy alcohol based solvents such as 2-methoxyethanol, 2-ethoxyethanol and 1-methoxy-2-propanol; ketone based solvents such as acetone, methyl ethyl ketone, methyl isobutyl ketone, methyl propyl ketone and cyclohexanone; ether based solvent such as propylene glycol monopropyl ether, propylene glycol monomethyl ether, ethylene glycol monoethyl ether, ethylene glycol monopropyl ether, ethylene glycol monobutyl ether, diethylene glycol monomethyl ether, diethyl glycol monoethyl ether, diethyl glycol monopropyl ether, diethyl glycol monobutyl ether and diethylene glycol-2-ethylhexyl ether; aromatic solvent such as benzene, toluene and xylene, and the like. These may be used alone or in combination.

Meanwhile, according to another embodiment of the present disclosure, a display device including the window cover for flexible display device of the embodiment can be provided.

The display device can be used as a flat-shaped as well as a curved, bendable, flexible, rollable or foldable-shaped mobile communication terminal, a touch panel of a smartphone or a tablet PC, and cover substrate or element substrate of various displays.

An example of the flexible display device may be a flexible light emitting element display device.

For example, in the organic light emitting diode (OLED) display, a cover window including the polymer film may be positioned on an outer portion in a direction in which light or an image is emitted, and a cathode providing electrons, an electron transport layer, an emission layer, a hole transport layer, and an anode providing holes may be sequentially formed.

Further, the organic light emitting diode (OLED) display may further include a hole injection layer (HIL) and an electron injection layer (EIL).

In order to allow the organic light emitting diode (OLED) display to serve and act as a flexible display, in addition to using the polymer film as the cover window, a material having predetermined elasticity may be used in negative and positive electrodes and each of the constituent components.

Another example of the flexible display device may be a rollable display or foldable display device.

The rollable display may have various structures according to an application field, a specific shape, and the like. For example, the rollable display device may have a structure including a cover plastic window, a touch panel, a polarizing plate, a barrier film, a light emitting element (OLED element, or the like), a transparent substrate, or the like.

### Advantageous Effects

According to the present disclosure, there can be provided a cover window for flexible display device and a flexible display device, which is implemented so as to simultaneously satisfy the physical property balance between flexibility and high hardness, particularly causes almost no damage to the film even by repeated bending or folding operations, and thereby, can be easily applied to a bendable, flexible, rollable, or foldable mobile device, a display device, or the like.

Since the cover window for flexible display device can have physical properties that can replace tempered glass and the like, it can have characteristics to a degree at which it may not be broken by pressure or force applied from the outside and also can be sufficiently warped and folded.

Further, the cover window for flexible display device exhibits flexibility, bending property, high hardness, scratch resistance and high transparency, and hardly has a risk of damaging the film even by repetitive, continuous bending or long-time folding state, and thus, can be usefully applied to bendable, flexible, rollable or foldable mobile devices, display devices, front boards and display unit of various instrument panels, and the like.

### BRIEF DESCRIPTION OF THE DRAWINGS

FIG. 1 schematically shows a method for evaluating dynamic bending characteristics.

FIG. 2 shows the FT-IR spectrum measured for the polysiloxane of Preparation Example 2.

Hereinafter, the present disclosure will be described in more detail by way of examples. However, these examples are for illustrative purposes only, and the scope of the present disclosure is not limited thereby.

### PREPARATION EXAMPLE

### Preparation Example 1: Preparation of a Composition for Forming a Hard Coating Layer

60 wt % of urethane acrylate oligomer (UF-8001G, Kyoeisha Chemical), 37 wt % of methylethylketone, 2.5 wt % of a photoinitiator (1-184, Ciba) and 0.5 wt % of a labeling agent (BYK-3570, BYK Chemie) were blended using a stirrer and filtered through a filter to prepare a composition for forming a hard coat layer.

### Preparation Example 2: Preparation of Polysiloxane A

A silane monomer 3-glycidoxypropyltrimethoxysilane (GPTMS, KBM-403™, Shin-Etsu), water and toluene were added to a 1000 mL 3-neck flask, mixed and stirred (GPTMS:water=1 mol:3 mol).

Next, a basic catalyst (trimethylammonium hydroxide; TMAH) was added to the resulting mixed solution in an amount of 1 part by weight based on 100 parts by weight of the silane monomer, and the mixture was reacted at 100° C. for 2 hours to prepare polysiloxane A having the following composition containing 100 mol % of glycidoxypropyl modified silicone (hereinafter referred to as GP).

The FT-IR spectrum was measured by the ATR method, and the transmittance intensity of the cage-type polysiloxane with respect to the ladder-type polysiloxane in the prepared polysiloxane was measured. As a result, it was found to be 1.4. The actually measured FT-IR spectrum is shown in FIG. 2 below.

### Comparative Preparation Example: Preparation of Polysiloxane B

A silane monomer 3-glycidoxypropyltrimethoxysilane (GPTMS, KBM-403™, Shin-Etsu), water and toluene were added to a 1000 mL 3-neck flask, mixed and stirred (GPTMS:water=1 mol:3 mol).

Next, a basic catalyst (trimethylammonium hydroxide; TMAH) was added to the resulting mixed solution in an amount of 1 part by weight based on 100 parts by weight of the silane monomer, and the mixture was reacted at 100° C. for 8 hours to prepare polysiloxane B having the following composition containing 100 mol % of glycidoxypropyl modified silicone (hereinafter referred to as GP).

The FT-IR spectrum was measured by the ATR method, the transmittance intensity of the cage-type polysiloxane to the ladder-type polysiloxane in the prepared polysiloxane was measured, and as a result, it was found to be 1.1.

### Examples and Comparative Examples

### Example 1

The composition for forming a hard coating layer prepared in Preparation Example 1 was coated onto one surface of a polyimide film having a thickness of 15 cm×20 cm and a thickness of 50 μm (the elastic modulus value of 7.0 GPa as measured according to ASTM D882), and was irradiated with ultraviolet rays using a lamp (irradiation amount: 1,000 mJ/cm²), and photocured to form a first coating layer having a thickness of 10 μm.

100 g of polysiloxane A prepared in Preparation Example 2, 48 g of elastomeric polymer (polycaprolactonediol, Mn=500 g Da), 3 g of an initiator 1-250 (BASF), 0.6 g of a leveling agent F-477 (DIC) and 5 g of methyl ethyl ketone as a solvent were mixed to prepare a resin composition for forming a second coating layer.

The resin composition for forming the second coating layer was coated onto the other side of the polyimide film, and was irradiated with ultraviolet rays using a lamp (irradiation amount: 1,000 mJ/cm 2) and photocured to form a second coating layer having a thickness of 40 μm.

### Example 2

An optical laminate for a cover window of a flexible display device was manufactured in the same manner as in Example 1, except that the resin composition for forming the second coating layer using 16 g of an elastomeric polymer was used.

### Example 3

An optical laminate for a cover window of a flexible display device was manufactured in the same manner as in Example 1, except that a 60 μm second coating layer was formed with the resin composition for forming the second coating layer using 16 g of an elastomeric polymer to manufacture an optical laminate having a total thickness of 120 μm.

### Comparative Example 1

An optical laminate for a cover window of a flexible display device was manufactured in the same manner as in Example 1, except that when preparing the resin composition for forming the second coating layer, polysiloxane B of Comparative Preparation Example was used instead of polysiloxane A prepared in Preparation Example.

### Comparative Example 2

The first coating layer was formed on one surface of the polyimide by the same method as in Example 1.

An optical clear adhesive film (3M company, thickness: 20 μm) and CPI (Kolon, thickness: μm) were sequentially stacked on the other side of the polyimide using a lamination device at room temperature to manufacture an optical laminate for a cover window of a flexible display device including a functional layer.

### Experimental Example

The physical properties of the optical laminates prepared in Examples and Comparative Examples were measured by the following method, and the results are shown in Table 1 below.

An optical clear adhesive film (3M, thickness: 20 μm) and CPI (Kolon, thickness: 20 μm) were sequentially stacked on the second coating layer using a lamination device at room temperature to manufacture an optical laminate for a cover window of a flexible display device including a functional layer.

After laminating the functional layer, a pencil was fixed to the surface of the first coating layer of the optical laminate at a load of 300 g and an angle of 45° using a pencil hardness tester, and scratched a total of 5 times by 20 mm for each pencil hardness, it was judged with the naked eyes whether or not it was scratched, and the maximum pencil hardness that did not cause surface damage (cracks of 1 mm or more) 3 times or more was measured.

The maximum pencil hardness that did not cause surface damage (cracks of 1 mm or more) immediately after laminating the functional layer is defined by the initial Dent value, and the maximum pencil hardness that did not cause surface damage (cracks of 1 mm or more) after the functional layer was laminated and left at room temperature for 24 hours is defined by a late Dent value.

### 2. Dynamic Bending Characteristics

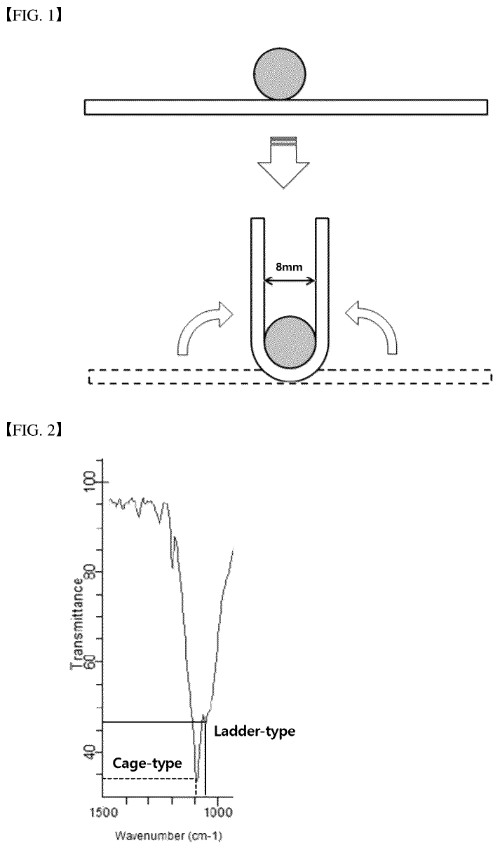

FIG. 1 schematically shows a method for evaluating dynamic bending characteristics for an optical laminate according to one embodiment of the present disclosure.

Specifically, the optical laminate was cut, but laser cut to a size of 80×140 mm so as to minimize fine cracks at the edge portion. The laser-cut film was placed on the measuring device, the first coating layer was set inside, and the interval (inner curvature diameter) of the folded part was set 8 mm. Continuous operations of folding and unfoling both sides of the first coating layer at 90 degrees toward the bottom surface (the speed at which the film folds was 1 time/second at 25° C.) were repeated 200,000 times at room temperature, and room temperature dynamic bending characteristics were evaluated according to the following criteria.

Excellent: No generation of cracks of 1 mm or more

Defective: Generation of cracks of 1 mm or more

### 3. Pressing Resistance

After the surface of the first coating layer of the optical laminate was rubbed back and forth in a circle with a Wacom pen 200 times under a load of 250 g, and and checking whether there is any pressing on the path of the pen, and it was confirmed whether or not pressing occurred on the path of the pen. It was judged as ‘excellent’ if no pressing was observed inside, and it was judged as ‘defective’ if pressing was observed.

### 4. Scratch Resistance

A load of 500 gf was applied to the steel wool (#0000), and the surface of the first coating layer of the optical laminate was rubbed back and forth 1000 times at a speed of 40 rpm, and it was observed with an optical microscope whether scratches occurred on the surface. It was judged as ‘excellent’ if no scratches were observed under an optical microscope, and it was judged as ‘deffective’ if a scratches were observed, specifically, if one or more scratches of 1 mm or more were observed.

TABLE 1

| | | | | Comparative | Comparative |
|---|---|---|---|---|---|
| | Example 1 | Example 2 | Example 3 | Example 1 | Example 2 |
| Dent characteristic | B −> 2H | HB −> 3H | HB −> 3H | B −> H | 3B −> B |
| Room temperature | Excellent | Excellent | Excellent | Excellent | Excellent |
| dynamic bending | | | | | |
| characteristics | | | | | |
| Pressing resistance | OK | OK | OK | OK | NG |
| Scratch resistance | Excellent | Excellent | Excellent | Excellent | Defective |

According to Table 1, it was confirmed that the cover windows for flexible display devices of Examples 1 to 3 have excellent scratch resistance and good dynamic bending characteristics. In particular, as confirmed from the test results of the dent characteristics and the pressing resistance, it has sufficient impact resistance and anti-pressing performance even in a state formed on a predetermined substrate.

On the contrary, it was confirmed that the cover windows of Comparative Examples 1 and 2 do not have sufficient pressing resistance performance (Dent characteristic) even if a certain level of scratch resistance is secured.

1. A cover window for flexible display device comprising:
a light-transmitting substrate;
a first coating layer formed on one surface of the light-transmitting substrate and having a thickness of 200 μm or less; and
a second coating layer formed on the other surface of the light-transmitting substrate opposite to the first coating layer and including polysiloxane containing two or more repeating units having different structures.

2. The cover window for flexible display device of claim 1, wherein:
the cover window does not generate cracks of 1 mm or more when bending the middle of the cover window to be at an interval of 8 mm in the middle of the first coating layer while folding both sides of the first coating layer toward the inside of the first coating layer at an angle of 90 degrees and unfolding both sides of the first coating layer at 90 degrees toward the bottom surface, and repeating 200,000 times of the folding and the unfolding at a speed of 1 time/second at room temperature.

3. The cover window for flexible display device of claim 1, wherein:
a maximum hardness that pressing does not generate in a path through which a pencil passes on the surface of the first coating layer according to JIS K5400 standard using a pencil hardness tester is at least 2B, and wherein the maximum hardness is measured immediately after a functional layer of 10 μm to 300 μm is formed on one surface of the second coating layer formed on the other surface of the light-transmitting substrate opposite to the first coating layer.

4. The cover window for flexible display device of claim 1, wherein:
a FT-IR spectrum as measured by an attenuated total reflection (ATR) method using polysiloxane containing two or more repeating units having different structures, has at least one peak in the region of 1010 cm⁻¹ to 1070 cm⁻¹, and has at least one peak in the region of 1075 cm⁻¹ to 1130 cm⁻¹.

5. The cover window for flexible display device of claim 1, wherein:
the polysiloxane containing two or more repeating units having different structures comprises a cage-type polysiloxane repeating unit in which a crosslinkable functional group is substituted, and a ladder-type polysiloxane repeating unit in which the crosslinkable functional group is substituted.

6. The cover window for flexible display device of claim 4, wherein:
a peak intensity ratio (I₂/I₁) of intensity (I₂) of the peak with the highest intensity among at least one peak appearing in the region of 1075 cm⁻¹ to 1130 cm⁻¹ to intensity (I₁) of the peak with the highest intensity among at least one peak appearing in the region of 1010 cm⁻¹ to 1070 cm⁻¹ is 1.2 or more and 2.5 or less.

7. The cover window for flexible display device of claim 5, wherein:
the crosslinkable functional group comprises any one selected from the group consisting of an alicyclic epoxy group and a functional group represented by the following Chemical Formula 1: 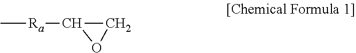
wherein, in the Chemical Formula 1,
Rₐ is a substituted or unsubstituted alkylene group having 1 to 6 carbon atoms, a substituted or unsubstituted alkenylene group having 2 to 20 carbon atoms, a substituted or unsubstituted alkynylene group having 2 to 20 carbon atoms, —R_{b}—CH═CH—COO—R_{c}—, —R_{d}—OCO—CH═CH—Rₑ—, —R_{f}OR_{g}—, —RₕCOORᵢ—, or —RⱼOCORₖ—, and
R_{b} to Rₖ are each independently a single bond, or a substituted or unsubstituted alkylene group having 1 to 6 carbon atoms.

8. The cover window for flexible display device of claim 1, wherein:
the second coating layer contains 10 parts by weight or more and 80 parts by weight or less of an elastomeric polymer with respect to 100 parts by weight of the polysiloxane containing two or more repeating units having different structures.

9. The cover window for flexible display device of claim 1, wherein:
the first coating layer comprises a (meth)acrylate resin or an epoxy resin.

10. The cover window for flexible display device of claim 9, wherein:
the (meth)acrylate resin comprises a (co)polymer of at least one compound selected from the group consisting of a monofunctional acrylate monomer, polyfunctional acrylate monomer and a polyfunctional urethane acrylate oligomer.

11. The cover window for flexible display device of claim 1,
which comprises a functional layer formed on one surface of the second coating layer formed on the other surface of the light-transmitting substrate opposite to the first coating layer,
wherein the functional layer is any one of a black matrix film, a polarizing film, an ultraviolet blocking film, a release film, and a conductive film.

12. The cover window for flexible display device of claim 1, wherein:
the light-transmitting substrate has a thickness of 5 μm to 100 μm, and
the first coating layer has a thickness of 5 μm to 200 μm.

13. The cover window for flexible display device of claim 1, wherein:
the second coating layer has a thickness of 5 μm to 200 μm.

14. The cover window for flexible display device of claim 1, wherein:
a ratio of a thickness of the first coating layer to a thickness of the light-transmitting substrate is 0.1 to 2.0.

15. The cover window for flexible display device of claim 1, wherein:
a ratio of a thickness of the second coating layer to a thickness of the first coating layer is 1.0 to 10.0.

16. The cover window for flexible display device of claim 1, wherein:
the light-transmitting substrate comprises at least one resin selected from the group consisting of polyester-based resin, cellulose-based resin, polycarbonate-based resin, acryl-based resin, styrene-based resin, polyolefin-based resin, polyimide-based resin, polyamideimide-based resin, polyethersulfone-based resin and sulfone-based resin.

17. The cover window for flexible display device of claim 1, wherein:
the cover window for flexible display device does not generate cracks having a length of 3 mm or more when wound on a cylindrical mandrel with a diameter of 3 mm.

18. A flexible display device comprising the cover window for flexible display device of claim 1.
